(19) United States
(12) Patent Application Publication
(10) Pub. No.: US 2016/0149327 A1
(43) Pub. Date: May 26, 2016

(54) ANGLED INTERPOSER INTERCONNECT SYSTEMS

(71) Applicant: International Business Machines Corporation, Armonk, NY (US)

(72) Inventors: John R. Dangler, Rochester, MN (US); Matthew S. Doyle, Rochester, MN (US); Mark D. Plucinski, Rochester, MN (US); Stephen C. White, Manassas Park, VA (US)

(21) Appl. No.: 14/548,904

(22) Filed: Nov. 20, 2014

(51) Int. Cl. H01R 12/85; H01R 12/71

(52) U.S. Cl. CPC H01R 12/85; H01R 12/714

(57) ABSTRACT

A method and structures are provided for implementing angled interposer interconnect systems. The angled interposer interconnect systems include an angled interconnect having a selected interconnect angle including a plurality of land grid array (LGA) contacts. The selected interconnect angle is provided in a provided within a predefined range between zero degrees one hundred eighty (180) degrees. Selected connector LGA contacts have substantially matching length for enhanced signal integrity performance.

### FIELD OF THE INVENTION

The present invention relates generally to the data processing field, and more particularly, relates to a method and structures for implementing angled interposer interconnect systems.

### DESCRIPTION OF THE RELATED ART

Most interconnect systems facilitate 0, 90 or 180 degree interconnection. As mechanical packaging requirements become more aggressive interconnections at various non standard angles are needed. Specific 22 degree angled connectors are available for dual inline memory module (DIMM) applications.

### SUMMARY OF THE INVENTION

Principal aspects of the present invention are to provide a method and structures for implementing angled interposer interconnect systems. Other important aspects of the present invention are to provide such method and structures substantially without negative effects and to overcome many of the disadvantages of prior art arrangements.

In brief, a method and structures are provided for implementing angled interposer interconnect systems. The angled interposer interconnect systems include an angled interconnect having a selected interconnect angle including a plurality of land grid array (LGA) contacts. The selected interconnect angle is provided within a predefined range between zero degrees one hundred eighty (180) degrees. Selected connector LGA contacts have substantially matching length for enhanced signal integrity performance.

In accordance with features of the invention, modified bolsters are provided with the land grid array (LGA) contacts.

In accordance with features of the invention, the angled interposer interconnect systems enable enhanced flexibility in mechanical design.

In accordance with features of the invention, the angled interposer interconnect systems enable enhanced heat transfer to ambient air.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 schematically illustrates not to scale an example structure for implementing angled interposer interconnect systems in accordance with the preferred embodiment;

FIG. 2 schematically illustrates not to scale an example contact structure for implementing angled interposer interconnect systems in accordance with the preferred embodiment;

FIGS. 3A and 3B schematically illustrate not to scale respective example structure for implementing angled interposer interconnect systems in accordance with the preferred embodiment;

FIG. 4 schematically illustrates an example pre-form enabling 90 degree connector with constant LGA contact length in accordance with the preferred embodiment;

FIG. 5 schematically illustrates an example 90 degree connector with different length LGA in accordance with the preferred embodiment;

FIG. 6 schematically illustrates not to scale an example structure for implementing modular connector concept to customize angled interposer interconnect systems in accordance with the preferred embodiment;

FIG. 7 schematically illustrates not to scale an example structure for implementing angled interposer interconnect systems in accordance with the preferred embodiment; and

FIG. 8 schematically illustrates not to scale an example hybrid pre-form for implementing angled interposer interconnect systems in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and structures are provided for implementing angled interposer interconnect systems, enabling enhanced flexibility in mechanical design. Additional angled connector systems are needed to meet packaging challenges. Interconnects that match lengths are needed to improve signal integrity performance.

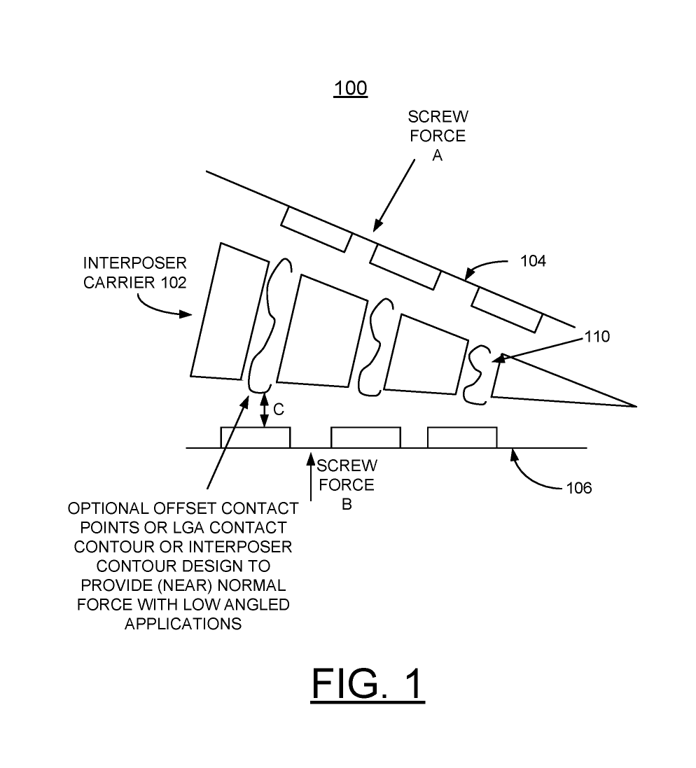

Having reference now to the drawings, in FIG. 1, there is shown an example structure generally designated by the reference character 100 for implementing angled interposer interconnect systems in accordance with preferred embodiments.

In accordance with features of the invention, the structure or angled interposer interconnect system 100 includes an interposer carrier 102 that is sized and arranged for providing a selected low angle connection to be positioned between a first board or chip 104 and a second board or chip 106, as shown. The interposer carrier 102 includes a plurality of different length contacts 110 allowing for the angled connection system 100. A screw force indicated by a respective arrow labeled SCREW FORCE A, SCREW FORCE B, respectively is applied to the first board or chip 104 and the second board or chip 106. As illustrated by an arrow C, optional offset contact points or LGA contact contour or interposer contour design provide normal force with low angled applications.

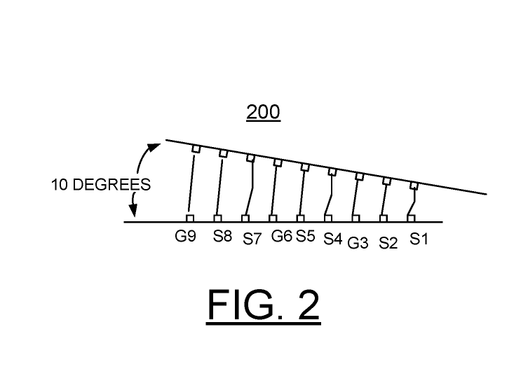

Referring now to FIG. 2, there is schematically shown an example contact structure generally designated by the reference character 200 for implementing angled interposer interconnect systems in accordance with the preferred embodiment. The contact structure 200 includes modified contacts indicated by labels: S1, S2, G3, S4, S5, G6, S7, S8, and G9 with an angle of 10 degrees. The contact structure 200 is used for a 3 pair differential connector with a signal, signal, ground configuration of S1, S2, G3, S4, S5, G6, S7, S8, and G9. The modified contacts include a pair matching contact length for signals pairs S1 and S2; S4 and S5; and S7 and S8. For example, as shown in the following Table A:

TABLE A

| Unmatched lengths | Matched lengths |
|---|---|
| S1 52.9 | 53.3 |
| S2 53.3 | 53.3 |
| G3 53.6 | 53.6 |
| S4 54.0 | 54.3 |
| S5 54.3 | 54.3 |
| G6 54.7 | 54.7 |
| S7 55.0 | 55.4 |
| S8 55.4 | 55.4 |
| G9 55.7 | 57.4 |

As shown, the first pair S1, S2 to the last pair S7, S8 matching contact length differential is 2.5 mm (98 mils). As shown, matching length is achieved within the first pair S1, S2, within the second pair S4, S5 and within the third pair S7, S8.

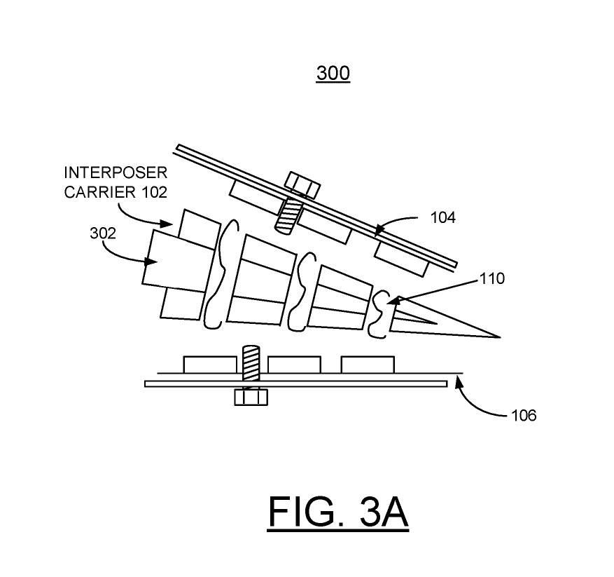

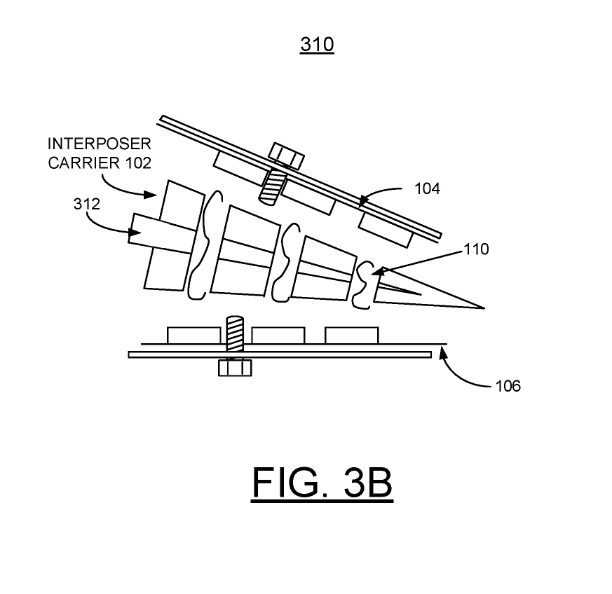

Referring now to FIGS. 3A and 3B, there is schematically shown respective example structure respectively generally designated by the reference character 300, 310 for implementing angled interposer interconnect systems in accordance with the preferred embodiment. Each of the structures or angled interposer interconnect systems 300, 310 includes the interposer carrier 102 providing a selected low angle connection positioned between the first board or chip 104 and the second board or chip 106. The interposer carrier 102 includes the plurality of different length contacts 110 allowing for the angled connection system 100.

As shown in FIGS. 3A and 3B, an additional integrated bolster 302, 312, respectively provided with the interposer carrier 102. A material gradient in the integrated bolster 302, 312 can assist in offsetting unmatched contact lengths.

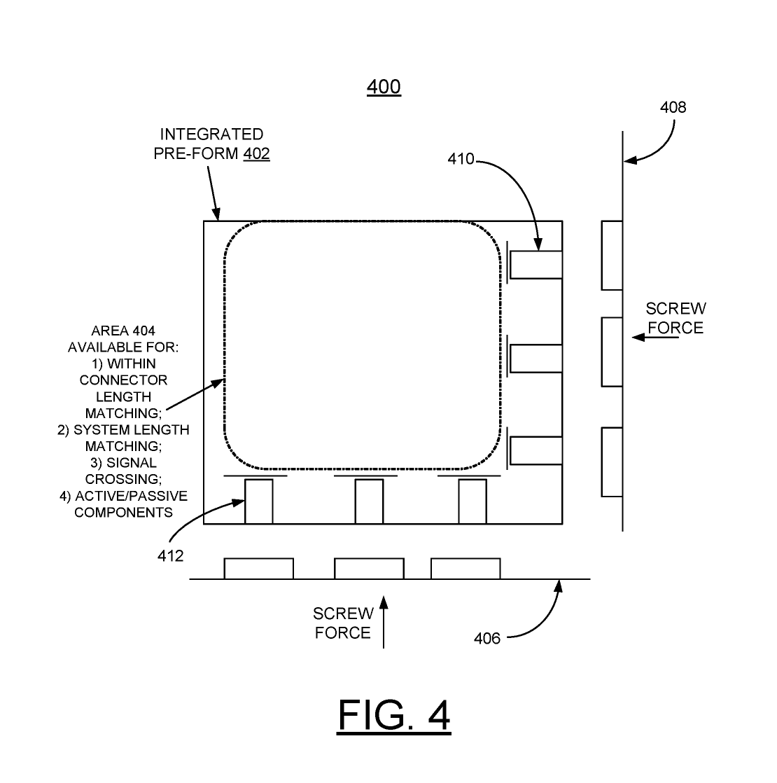

Referring now to FIG. 4, there is schematically shown an example pre-form structure generally designated by the reference character 400 enabling 90 degree connector with constant LGA contact length in accordance with the preferred embodiment. The pre-form structure 400 includes an integrated pre-form 402 with an area 404 indicated in dotted line that is available for 1) within connector length matching; 2) system length matching; 3) signal crossing; and 4) active and passive components including redrive, filters, power conversion and the like. The pre-form structure 400 is used with a first board or chip 406 and a second board or chip 408 cooperating with respective pre-form structure cooperating portions 410, 412.

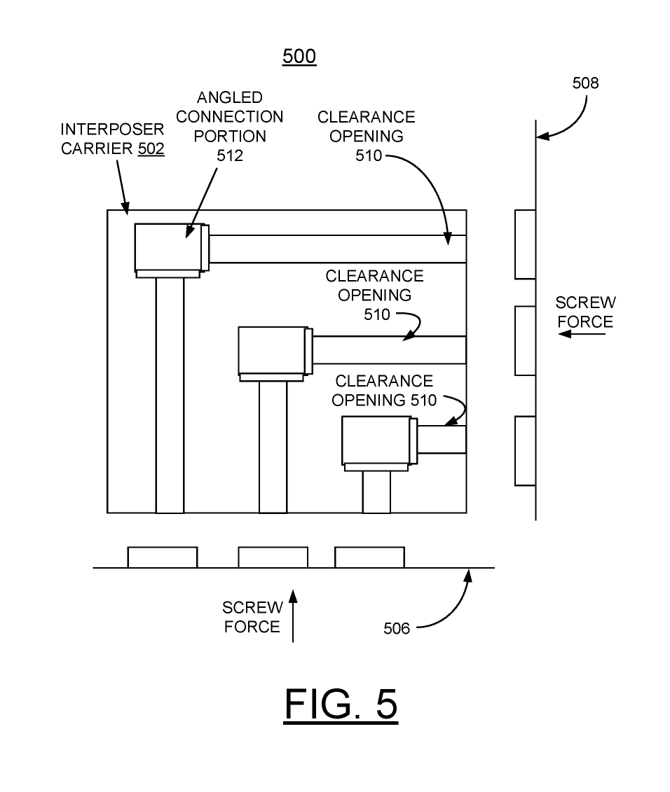

Referring now to FIG. 5, there is schematically shown an example 90 degree connector with different length LGA generally designated by the reference character 500 in accordance with the preferred embodiment. The 90 degree connector 500 includes an interposer carrier 502 used with a first board or chip 506 and a second board or chip 508. The 90 degree connector 500 includes a respective clearance opening 510 for receiving different length LGA contacts. Each respective clearance opening 510 includes an angled connection portion 512.

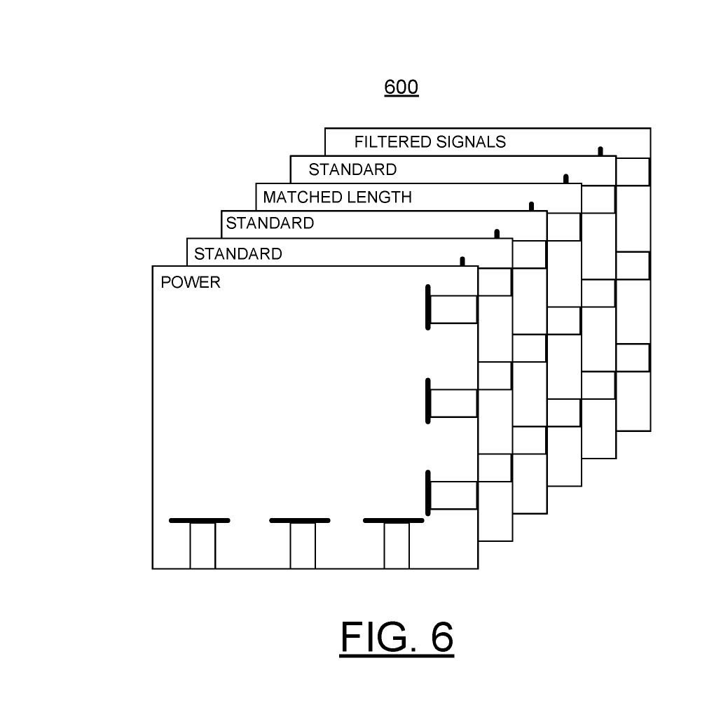

Referring now to FIG. 6, there is schematically shown an example modular connector structure generally designated by the reference character 600 for implementing modular connector concept to customize angled interposer interconnect systems in accordance with the preferred embodiment. Modular connector structure 600 illustrates example customized connector features of Power, Standard, Standard, Matched Length, Standard, and Filtered Signals.

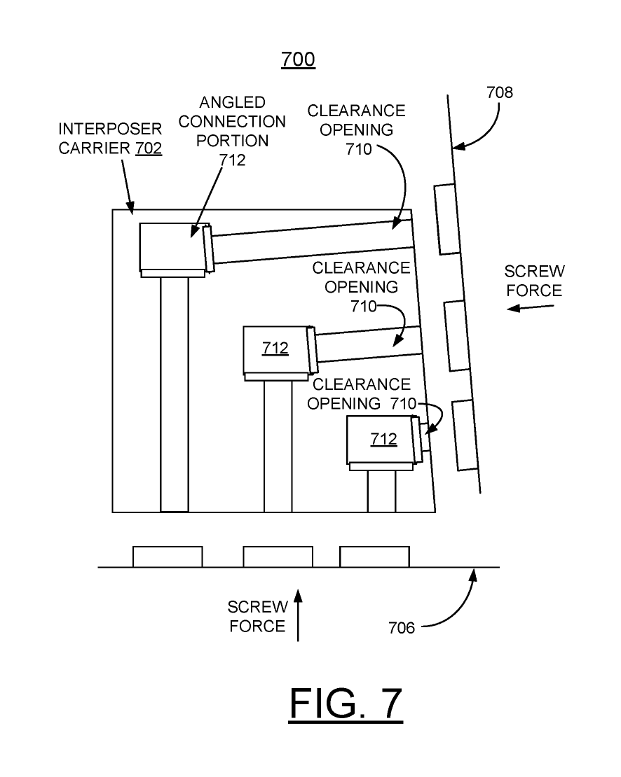

Referring now to FIG. 7, there is schematically shown an example structure generally designated by the reference character 700 for implementing angled interposer interconnect systems with variable LGA contact length in accordance with the preferred embodiment. The angled connector 700 includes an interposer carrier 702 used with a first board or chip 706 and a second board or chip 708. The angled connector 700 includes a respective clearance opening 710 for receiving different length LGA contacts. Each respective clearance opening 710 includes an angled connection portion 712.

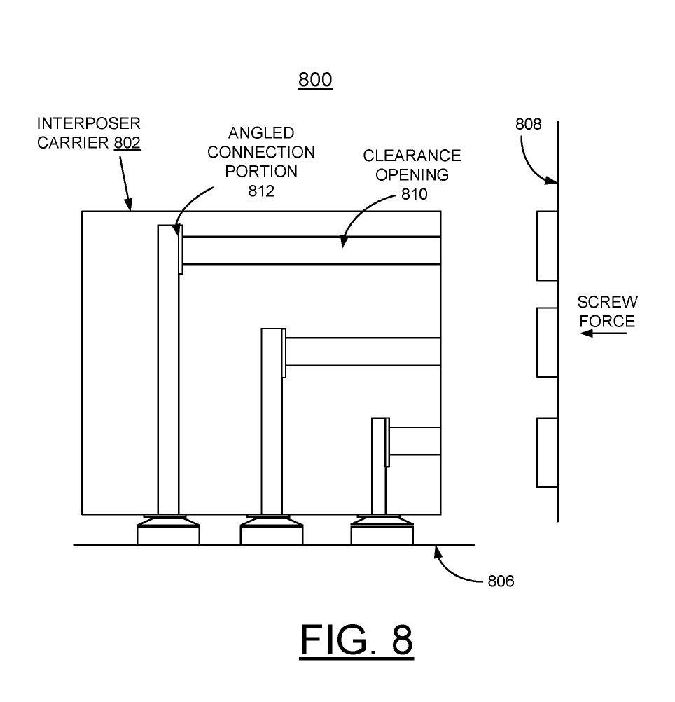

Referring now to FIG. 8, there is schematically shown an example hybrid pre-form generally designated by the reference character 800 for implementing angled interposer interconnect systems in accordance with the preferred embodiment. The pre-form 800 includes an interposer carrier 802 used with a fixed first board or chip 806 and a second board or chip 808 receiving a screw force indicated by an arrow SCREW FORCE, and including includes a respective clearance opening 810 for receiving different length LGA contacts. Each respective clearance opening 810 includes an angled connection portion 812.

While the present invention has been described with reference to the details of the embodiments of the invention shown in the drawing, these details are not intended to limit the scope of the invention as claimed in the appended claims.

1. A structure for implementing angled interposer interconnect systems comprising:
an angled interconnect having a selected interconnect angle positioned between a first board and a second board, said selected interconnect angle provided within a predefined range;
said angled interconnect including at least one opening for receiving land grid array (LGA) contacts; said land grid array (LGA) contacts including different length LGA contacts, said angled interconnect enabling enhanced mechanical design flexibility.

2. The structure as recited in claim 1 wherein said predefined range of said selected interconnect angle is between zero degrees one hundred eighty (180) degrees.

3-4. (canceled)

5. The structure as recited in claim 1 include selected LGA contacts being modified to provide a matching contact length differential.

6. The structure as recited in claim 5 wherein said matching contact length differential is provided with one of a signal pair of said selected LGA contacts.

7. A method for implementing angled interposer interconnect systems comprising:
providing an angled interconnect having a selected interconnect angle positioned between a first board and a second board, said selected interconnect angle provided within a predefined range;
providing said angled interconnect including at least one opening for receiving land grid array (LGA) contacts; said land grid array (LGA) contacts including different length LGA contacts, said angled interconnect enabling enhanced mechanical design flexibility.

8. The method as recited in claim 7 wherein providing said angled interconnect including at least one opening for receiving land grid array (LGA) contacts includes providing variable length land grid array (LGA) contacts.

9. The method as recited in claim 7 wherein said predefined range of said selected interconnect angle is range between zero degrees one hundred eighty (180) degrees.

10. The method as recited in claim 7 wherein providing said angled interconnect including at least one opening for receiving land grid array (LGA) contacts includes modifying selected LGA contacts to provide a matching contact length differential.

11. The method as recited in claim 10 wherein said matching contact length differential is provided with one of a signal pair of said selected LGA contacts.

12-13. (canceled)
